(19) United States
(12) Patent Application Publication
(10) Pub. No.: US 2004/0136795 A1
(43) Pub. Date: Jul. 15, 2004

(54) Laser centering mechanism of a drilling machine

(76) Inventor: Sean Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/340,800

(22) Filed: Jan. 13, 2003

(51) Int. Cl. B23B 49/00

(52) U.S. Cl. 408/16

(57) ABSTRACT

A laser centering mechanism of a drilling machine includes a support ring fitted around a support tube disposed right above the drill, first and second laser modules disposed on an edge of the support ring, and first and second adjustment combinations for holding the support ring around the support tube, and respectively for adjusting orientation of the first and the second laser modules relative to the tube. The laser modules are equipped with such lenses that laser lights emitted therefrom can form respective straight light lines on a plane thereunder, and the light lines will intersect to form a centering point on the plane. After rectification, under which the intersection is adjusted to be right under the sharp end of the drill, a predetermined point of a workpiece, on which a hole is to be drilled, can be easily positioned right under the drill precisely owing to the intersection.

### BACKGROUND OF THE INVENTION

1. Field of the Invention

The present invention relates to a laser centering mechanism of a drilling machine, more particularly one, which is disposed right above a drill of a drilling machine, and which consists of two laser modules capable of emitting laser lights forming two perpendicularly intersecting light lines on a workpiece for helping a drill of the drilling machine to be centered on the point of the workpiece, on which a hole is to be drilled.

2. Brief Description of the Prior Art

Referring to FIG. 1, a conventional drilling machine has a support base 11, a support rod 12 joined to the base 11, and a table 13 supported on the support rod 12 for a workpiece 10 to be positioned on; fixing jaws 19 are disposed oil the table 12 for fixing the workpiece 10 in position; a power source 14 is disposed above the table 12, and has a support tube 17, and a transmission shaft (not shown), which sticks downwards within the support tube 17, and to which a drill chunk 15, and a drill 16 are connected. A control member 18 is joined to the support tube 17 so that the support tube 17 can be moved down for the drill 16 to drill holes on the workpiece 10 by means of operating the control member 18.

In order for the drill 16 to drill a hole on a workpiece at a predetermined position, the workpiece is usually first formed with a shallow mark at the predetermined point to be drilled by means of a centering punch before it is fixed on the table 13 with the jaws 19. A shallow hole can be first drilled at the predetermined point of a workpiece with a centering drill instead before the drill 16 is used to drill a hole on the workpiece.

Both of the above ways is not very convenient to use because the operator has to watch carefully to establish whether the drill is centered on the shallow mark while he is operating the control member 18 to move the drill onto the workpiece, causing labor and time to increase in manufacturing. Consequently, the cost of production is relatively high.

### SUMMARY OF THE INVENTION

It is a main object of the present invention to provide a laser centering mechanism to a drilling machine, which consists of two laser modules capable of emitting laser lights forming two perpendicularly intersecting light lines on a workpiece for helping the drill of the drilling machine to be centered on a predtermined point of a workpiece, on which a hole is to be drilled.

The laser centering mechanism includes a support ring horizontally adjustably disposed right above the drill, first and second laser modules held with the support ring, and first and second adjustment combinations for adjusting orientation of the support ring relative to the drill so as to respectively adjust orientation of the first and the second laser modules. The laser modules are equipped with such lenses that laser lights emitted therefrom can form respective straight lines on an object positioned under them, and the straight lines formed on the object will intersect each other perpendicularly.

Before use of the laser centering mechanism with a drilling machine, rectification has to be done first, under which the intersection is adjusted to be right under the sharp end of the drill. It is relatively easy to position a predetermined point of a workpiece, on which a hole is to be drilled, under the sharp end of the drill precisely owing to the intersection.

### BRIEF DESCRIPTION OF THE DRAWINGS

The present invention will be better understood by reference to the accompanying drawings, wherein:

FIG. 1 is a front view of a conventional drilling machine as described in the Background,

FIG. 2 is a partial side view of the drilling machine according to the present invention,

FIG. 3 is an exploded perspective view of the laser centering mechanism of a drilling machine according to the present invention,

FIG. 4 is a partial cross-sectional view of the laser centering mechanism of the present invention, fitted to a drilling machine,

FIG. 5 is a cross-sectional view of the laser centering mechanism of the present invention, fitted to a drilling machine,

FIG. 6 is a view of the laser centering mechanism of a drilling machine under adjustment according to the present invention; and,

FIG. 7 is a view of a drilling machine equipped with the laser centering mechanism of the present invention in use.

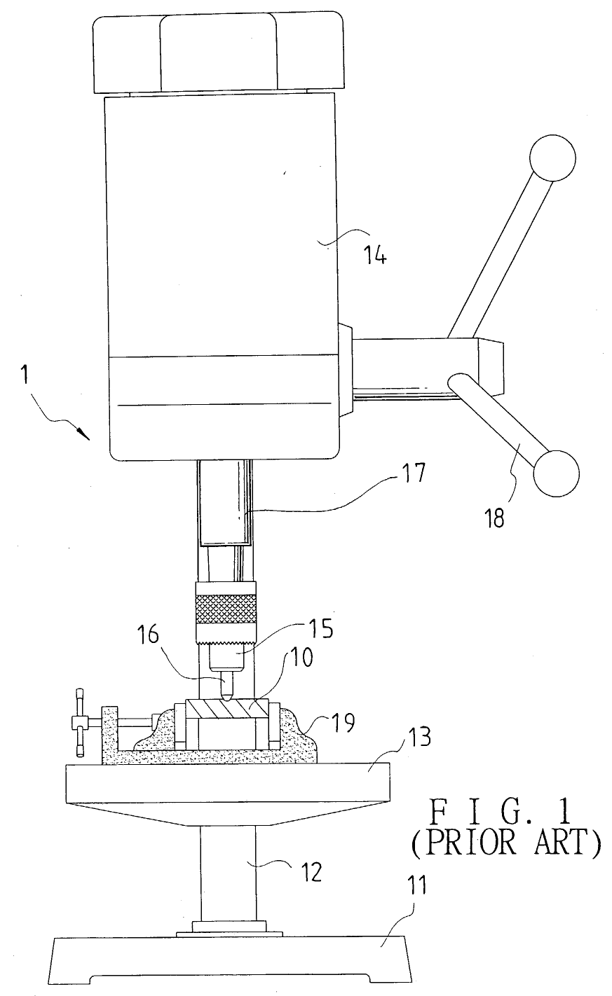

### DETAILED DESCRIPTION OF THE PREFERRED EMBODIMENTS

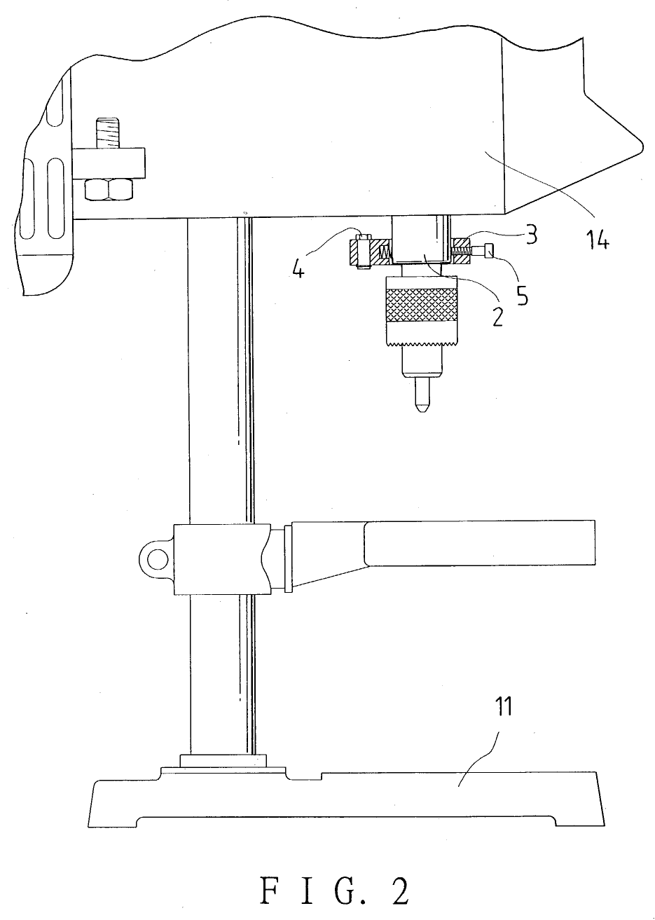

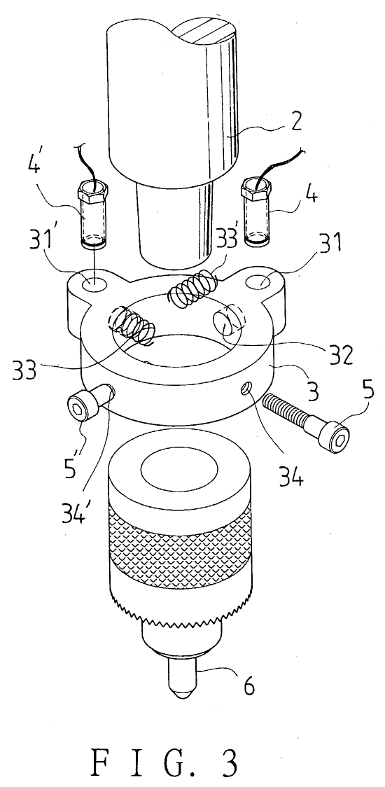

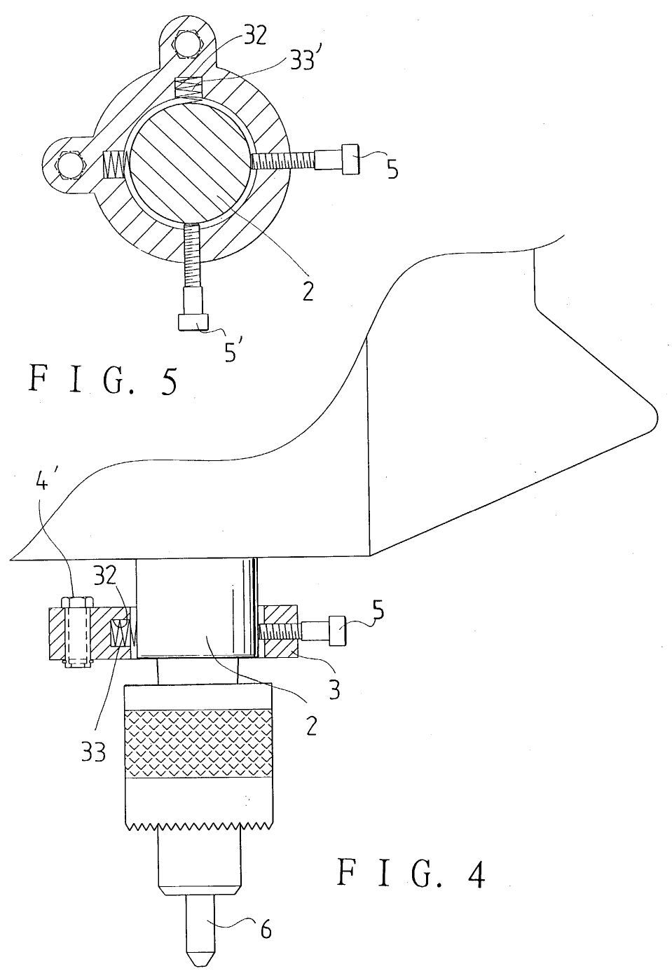

Referring to FIGS. 2 to 5, a laser centering mechanism 1 of a drilling machine according to the present invention includes a support ring 3, two laser modules 4, 4′, and two adjustment bolts 5, 5′; the support ring 3 is to be fitted around a support tube 2 of a drilling machine, and a transmission shaft (not shown) is disposed within the support tube 2, and connected to a drill 6 and a power source 14 at two ends thereof.

The support ring 3 is round, and includes a central hole (not numbered), and two holding portions, which extend from the round main body of the support ring 3, and each of which has a holding hole 31, 31′ having an axis parallel to the axis of the central hole; the holding holes 31, 31′ are arranged in such a way that two imaginary lines will be perpendicular to each other that connect axes of respective holes 31, 31′ and the center of the central hole. The support ring 3 further has holding cavities 32, 32′ formed on the other sides of respective holding holes 31, 31′. The ring 3 has through screw holes 34, 34′, which are faced with the holding cavities 32′, 32 respectively, and are preferably aligned with the respective holding cavities 32′, 32.

Elastic members 33 are held with the holding holes 31, 31′ with inner ends thereof sticking out from the holding holes 31, 31′.

The laser modules 4, and 4′ are disposed in the holding holes 31, and 31′ respectively, and each has a lens (not shown) fitted thereto that can make laser light emitted therefrom form a straight light line on a surface of a workpiece positioned under it, and the straight lines formed on the surface of a workpiece by the laser lights intersect each other perpendicularly to form a centering point. The lenses can be wave-shaped, cylindrical, or lozenge. The laser modules are not the subject of the present invention therefore they will not be detailed herein.

The adjustment bolts 5, and 5′ are screwed into the screw holes 34, and 34′ respectively. To secure the support ring 3 to the transmission support tube 2 of the drilling machine, the support ring 3 is fitted around the support tube 2 with the elastic members 33 contacting the support tube 2, and the adjustment bolts 5, and 5′ are screwed further through the screw holes 34, and 34′ to come into contact with the support tube 2.

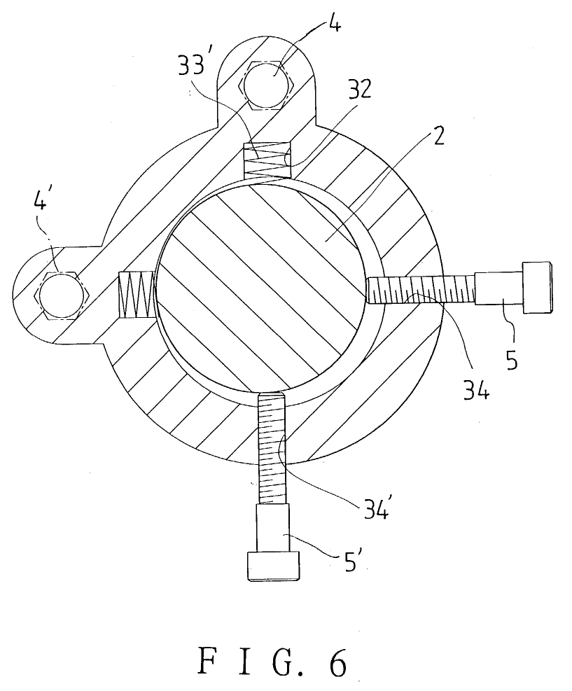

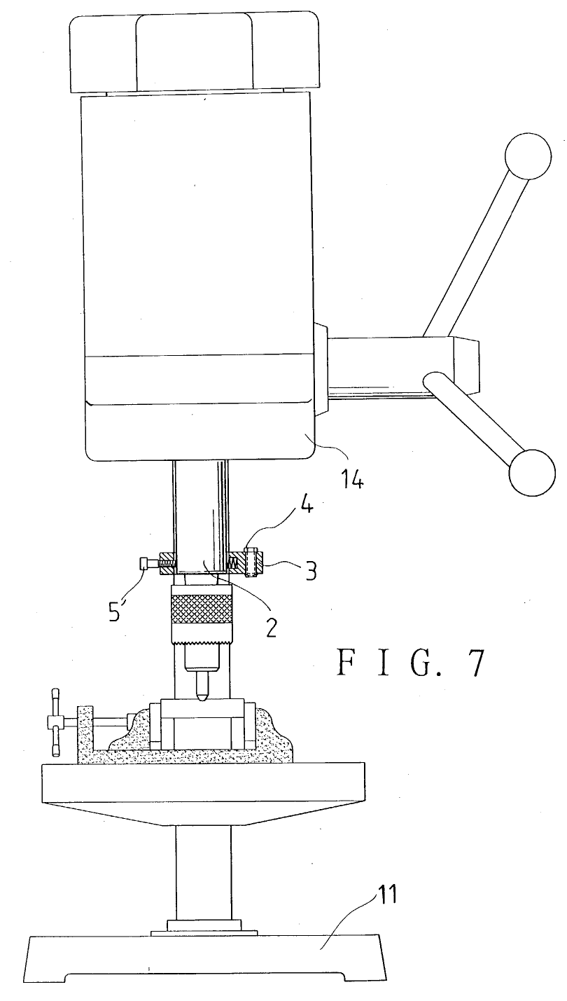

Thus, the orientation of the laser modules 4, and 4′ relative to the support tube 2 call be adjusted by means of the adjustment bolts 5, and 5′ respectively. After the present centering mechanism has been fitted to a drilling machine, rectification is required, in which a shallow mark is first drilled on an object with the drill 6, and then the adjustment bolts 5, 5′ are turned to adjust the orientation of the support ring 3 relative to the drill 6 for moving the centering intersection of the lines formed on the object by the laser lights of the laser modules 4, 4′ over the mark; referring to FIG. 6, when the adjustment bolt 5 is turned to move outwardly of the support ring 3, the laser module 4 will be adjusted leftwards relative to the support tube 2, and so the laser light of the laser module 4 will be, too, and when the adjustment bolt 5 is turned to move further into of the support ring 3, the laser module 4 will be adjusted rightwards relative to the support tube 2, and so the laser light of the laser module 4 will be, too; when the adjustment bolt 5′ is turned to move outwardly of the support ring 3, the laser module 4′ will be adjusted forwards, or upwards according to FIG. 6, relative to the support tube 2, and so the laser light of the laser module 4′ will be, too, and when the adjustment bolt 5′ is turned to move further into the support ring 3, the laser module 4′ will be adjusted rearwards, or downwards according to FIG. 6, relative to the support tube 2, and so the laser light of the laser module 4′ will be, too.

After the intersection of the lines formed on the object by the laser lights of the laser modules 4, 4′ is adjusted to be over the malls, rectification is finished, and the present centering mechanism can be used; When a work-piece on which a hole is to be drilled is placed on a table 13 of the drilling machine, the operator moves the workpiece for the intersection of the lines formed on the work-piece by the laser lights of the laser modules 4, 4′ to be over a marked predetermined point of the workpiece, on which a hole is to be drilled, and fixes the workpiece on the table 13 by means of fixing jaws 19. Thus, the predetermined point of a workpiece, on which a hole is to be drilled, can be easily positioned right under the drill 6 precisely. In other words, the drill 6 can be precisely centered on the predetermined point of the workpiece easily.

From the above description, it can be easily understood that the laser centering mechanism of the present invention has advantages as followings:

1. Because the laser centering mechanism can emit laser lights forming two perpendicularly intersecting lines on a workpiece for helping the predetermined point of a workpiece to be positioned right under the drill precesely, the operator doesn't have to use centering punches or centering drills to make a shallow hole on the predetermined point of the workpiece, on which a hole to be drilled. Therefore, a lot of labor and time are saved with the present laser centering mechanism.

2. Manufacturing cost is reduced, and the products are more competitive owing to reduction of time and labor in the drilling process.

What is claimed is:

1. A laser centering mechanism of a drilling machine, comprising
a support ring fitted around a support tube disposed right above a drill of a drilling machine;
first and second laser modules disposed on an edge of the support ring; the laser modules being arranged in such a way that two lines are perpendicular to each other which connect respective laser modules and a central point of the support ring;
the laser modules being equipped with such lenses that laser lights emitted therefrom form respective straight light lines on an object positioned under the support ring, and the straight light lines formed on the object by the laser lights of the modules intersect each other perpendicularly to form a centering point;
the support ring having first and second manual adjustment combinations for holding the support ring around the support tube, and respectively for adjusting orientation of the first and the second laser modules relative to the support tube with; the adjustment combinations being arranged in such a way that directions of movements of the laser modules under adjustment are perpendicular to each other.

2. The laser centering mechanism of a drilling machine as claimed in claim 1, wherein the first adjustment combination has an elastic member located on an inner side of the support ring and next to the second laser module to contact the support tube, and has a bolt screwed through the support ring and opposite to the elastic member for effecting change of orientation of the first laser module relative to the support tube with rotation thereof; and, the second adjustment combination has a second elastic member located on an inner side of the support ring and next to the first laser module to contact the support tube, and has a bolt screwed through the support ring and opposite to the second elastic member for effecting change of orientation of the second laser module relative to the support tube with rotation thereof.

3. The laser centering mechanism of a drilling machine as claimed in claim 1, wherein the lenses of the laser modules are wave-shaped.

4. The laser centering mechanism of a drilling machine as claimed in claim 1, wherein the lenses of the laser modules are cylindrical.

5. The laser centering mechanism of a drilling machine as claimed in claim 1, wherein the lenses of the laser modules are lozenge.
